(19) United States
(12) Patent Application Publication
(10) Pub. No.: US 2021/0392917 A1
(43) Pub. Date: Dec. 23, 2021

(54) NON-FROZEN COATED AERATED CONFECTIONERY

(71) Applicant: DSM IP ASSETS B.V., Heerlen (NL)

(72) Inventors: Jose BARBOSA, Kaiseraugst (CH); Zhenbo MA, Kaiseraugst (CH); Conroy Clive SALMON, Kaiseraugst (CH)

(21) Appl. No.: 17/287,646

(22) PCT Filed: Oct. 17, 2019
(86) PCT No.: PCT/EP2019/078133

§ 371 Date: Apr. 22, 2021

Related U.S. Application Data
(60) Provisional application No. 62/749,797, filed on Oct. 24, 2018.

(30) Foreign Application Priority Data
Oct. 29, 2018 (EP) 18203056.9

(51) Int. Cl. A23G 3/52; A23G 3/54; A23G 3/42; A23G 3/44; A23L 33/15; A23L 33/135; A23L 33/29

(52) U.S. Cl. CPC A23G 3/52; A23G 3/54; A23G 3/42; A23L 33/29; A23L 33/15; A23L 33/135; A23G 3/44

(57) ABSTRACT

The present invention is related to specific coated non-frozen aerated confectionery, which are fortified with specific nutrients. More particularly it relates to non-frozen aerated confectionery, such as a marshmallow.

The present invention is related to specific coated non-frozen aerated confectionery, which are fortified with specific nutrients. More particularly it relates to non-frozen aerated confectionery, such as a marshmallow.

For a healthy diet is very important to eat a sufficient amount of specific nutrients, especially dietary ingredients, such as vitamins, carotenoids, minerals as well as prebiotics and probiotics.

In nature these specific nutrients can be found in many sources. Some of these sources are not palatable.

While usually adult consumers have less problems to eat the desired amount of these specific nutrients, it may be difficult for children to consume them.

There are many dietary supplements on the market (usually in the form of pills or powder), which contain any of these specific nutrients. However, some consumers are less likely to eat such products.

Another possibility is to incorporate such specific nutrients in a kind of sweets, which are also very attractive for children.

A well-known product form are gummy bears or jelly babies.

Parents often give their children gummy vitamins because they are the only type of vitamins that their kids will take. It is easy to understand why, since many “gummies” are like candy. In fact, one gummy vitamin is i.e. made with “Jolly Rancher Sour” flavors.

The problems with gummy bears of jelly babies are that due to the way how they are made, especially the heat, which is needed causes problems in view of the specific nutrients. Usually these specific nutrients are not heat stable. To overcome that issue, it is nowadays necessary to overdose these specific nutrients so that the concentration in the final product is as is should be (as indicated on the package).

The goal of the present invention was to find a way (or a product form), which allows to delivery form for the specific nutrients, which are also accepted by kids.

We found that a new form of non-frozen coated aerated confectioneries is obtainable by a process, which is less harmful for the specific nutrients so that higher overages are not necessary. These of non-frozen aerated confectioneries are nevertheless more stable.

Furthermore, these new non-frozen coated aerated confectioneries can have a higher load of the specific nutrients in comparison to for example gummies.

In addition, the specific non-frozen coated aerated confectioneries have less sugar per serving while deliver the same level of vitamins and minerals than gummies.

The new non-frozen coated aerated confectioneries have many valuable advantages.

The present invention relates to a non-frozen coated confection (CC), consisting of
(a) an aerated core and
(b) a shell coating the core,
   wherein the core is fortified by at least one specific nutrient.

Preferably the confection according to the invention does not comprise any chocolate (not in the core and not in the shell). This means the confection is free of any chocolate.

Therefore, the present invention relates to a non-frozen coated confection (CC1), which is coated confection (CC), which does not comprise any chocolate.

Aerated confections can be classified into two sub-groups, grained and non-grained candies. Grained candies are made from supersaturated sucrose solution while non-grained candies are made from unsaturated sucrose solutions. The basic composition for marshmallows of all kinds includes water, a disaccharide sugar such as sucrose, a monosaccharide sugar such as dextrose or corn syrup, and a whipping agent such as gelatin. Suitable flavor and coloring materials may also be incorporated into the basic composition. Among the many formulas that are known for marshmallow production are those found in the following: “Candy Making as a Science and as an Art,” by Claude D. Barnett, Don Gussow Publications, Inc., New York, 1960, pp. 99-103; “An Encyclopedia of Candy and Ice Cream Making,” by Simon I. Leon, Chemical Publishing Company, New York, 1969, pp. 294-304, and, “A Textbook on Candy Making,” by Alfred E. Leighton, The Manufacturing Confectioner Publishing Company, Oak Park, Ill., 1952, pp. 55-58. See—also, for example, U.S. Pat. No. 3,607,309, issued Sep. 21, 1961 to E. S. Olney et al, and U.S. Pat. No. 2,847,311, issued Aug. 12, 1958 to Alexander J. Doumak. Soft marshmallow or “long grain” marshmallow has an elastic and chewy consistency and is the type usually associated with the term “marshmallow”. Sugar ratios are so regulated so that crystallinization of the sugars or “graining” does not take place within a reasonable period of time. To accomplish this reduction in the tendency to crystallize, corn syrup of various dextrose equivalents (“DE”) have been employed to inhibit the onset of crystallization.

The non-frozen coated confection according to the present invention consists of a core and a shell.

The core of the non-frozen coated confection according to the present invention is aerated. A preferred core is kind of a marshmallow.

The core comprises usually (and preferably and next to the specific nutrients) the following of four ingredients:
(i) sugar and/or sugar substitute,
(ii) water,
(iii) air, and
(iv) at least one whipping agent/aerator (usually a protein).

The sugar used in the aerated core of the confection according to the present invention can be any usually used sugar such as sucrose, corn syrup (glucose syrup) and/or invert sugar.

The aerated core comprises usually between 50-90 wt-%, based on the total weight of the core, of at least one sugar. Preferably the at least one sugar is chosen from the group consisting of sucrose, corn syrup (glucose syrup) and invert sugar.

The aerated core comprises water. The amount (in weight %, based on the total weight of the core) of water in the core is usually low. During the process of production of the aerated core, most of the water, which is used is evaporated. The aerated usually comprises up to 20 wt-%, based on the total weight of the core, of water.

The marshmallow is a foam, consisting of an aqueous continuous phase and a gaseous dispersed phase (in other words, a liquid with gas bubbles spread throughout). In addition to be a foam, this also makes marshmallows an “aerated” confection because it is made up to of 50% (by volume) air.

The whipping agent/aerator (iv) used to produce the marshmallow core is usually and preferably a protein (or a mixture of proteins). Preferred proteins are albumen (egg whites) and gelatin.

Albumen is a mixture of proteins found in egg whites and is utilized for its capacity to create foams.

Gelatin is made up of collagen, a structural protein derived from animal skin, connective tissue, and bones.

The aerated core usually comprises between 1-5 wt-%, based on the total weight of the core, of at least one whipping agent/aerator. Preferably the whipping agent/aerator is a protein. More preferably are albumen (egg whites) and/or gelatin.

The essential feature of the aerated core of the non-frozen coated confection according to the present invention is the presence of at least one specific nutrient.

The amount of specific nutrient can vary depending what specific nutrient (or mixture of specific nutrients) is used. Preferably the specific nutrients used in the aerated core of the non-frozen coated confection according to the present invention are dietary ingredients (such as vitamins, carotenoids, minerals) as well as prebiotics and probiotics.

Usually the aerated core of the non-frozen coated confection according to the present invention comprises an amount of 2-30 wt-%, based on the total weight of the core, of at least one specific nutrient (Preferably of dietary ingredients (such as vitamins, carotenoids, minerals) as well as prebiotics and probiotics).

The aerated core of the non-frozen coated confection according to the present invention can comprises additional ingredients, such as flavors, acids, colors, starches, etc. The amount of these (non-essential for the invention) ingredients can vary.

The non-frozen coated confection according to the present invention has a shell coating. This coating (layer) covers usually the aerated core in total.

The shell coating is usually (and preferably) a sugar coating. These coatings are well-known in the prior art.

Any known process (as used in the food or pharma industry can be used).

The thickness of the coating is usually up to 2 mm. Preferably (and ideally) the coating covers the aerated core equally.

The shell coating can comprise next to the sugar coating additional ingredients like colors, flavors, etc.

The ratio (regarding the weight) of the core and the shell of the non-frozen coated confection according to the present invention is from 1:0.5 to 1:2. This ratio depends strongly on the fluffiness of the core. The more air is in the core the more the ratio shifts to the shell.

The shell coating of the core should have such a hardness formed that is can be eaten easily by children (as well as adults).

The overall size as well as the shape of one non-frozen coated confection can vary. A usual and common form is sphere-like. The size (the longest diameter) if such a sphere is usually from 0.5 cm-3 cm.

But the shape can also be like a drum or any other form, which is appealing to be consumed.

The process of production of the non-frozen coated confection with an aerated core is usually the following
(1) the aerated core is produced and then
(2) the aerated core is coated (by a sugar coating).

### Process of Production of the Aerated Core

The aerated cores can be produced according to well-known process. A suitable way is the following:
(I) Gelatin is added to water and heated in with water bath (−50° C.). Allow at least 40 mins for hydration.
(II) In another pot, heat corn syrup with water and granulated sugar to 108° C.
(III) Pour cooked syrup into Hobart mixing bowl, then set mixer speed at medium using the whisk for mixing.
(IV) Add hydrated gelatin from step (I) and mix it. Slowly add the following: Egg Albumin, Malic acid, Tapioca starch, powdered sugar. Mix for a few minutes then add the at least one specific nutrient (in case more than one is added that can happen one after the other or in a mixture). Temperature is about 50° C.
(V) Finally add flavor (if needed) and mix for another few mins. Form core marshmallows with target serving size after cooling down to room temperature.

### Shell Coating (Sugar Coating) of the Aerated Core

The shell coating (sugar coating) of the aerated cores (which are produced as disclosed above) can be produced according to well-known process. A suitable way is the following:
(A) Gumming. Add 10 g of gumming solution slowly in the pan. Gently stir marshmallows to avoid sticking. Turn on air flow to dry the core.
(B) Soft panning. Turn off air flow. Add 7-10 g of syrup each time and wait for distribution of syrup. Add powder sugar until the center feels dry. Repeat the process 5 to 10 times.
(C) Hard panning. Add 7-10 g of syrup each time and wait for distribution of syrup. Turn on air flow to dry the core and turn off when the core is dry. Repeat the process 50 to 60 times.
(D) Hard panning with TiO₂. Add 7-10 g of syrup with TiO₂ each time and wait for distribution of syrup. Turn on air flow to dry the core and turn off when the core is dry. Repeat the process 5-15 times.
(E) Hard panning with color and flavor. Add 7-10 g of syrup with color and flavor each time and wait for distribution of syrup. Turn on air flow to dry the core and turn off when the core is dry. Repeat the process 10-20 times. For the last layer, reduce air flow to get smooth surface.
(F) Put coated marshmallows on a tray and dry overnight.
(G) Add 1 g of wax and polish for 20 mins in the pan with gentle tumbling.

The following Examples serve to illustrate the invention.

### EXAMPLES

All the following examples are made in analogy to the process as described in the description.

### Example 1: Aerated Confection Fortified with Vitamins as Dietary Ingredients

In the aerated confection a premix of the following composition is used (Table 1)

TABLE 1
Formulation of Premix

| | | | Unit of | BOM |
|---|---|---|---|---|
| Ingredient | potency | quantity | quantity | g/kg |
| IODINE | 0.01 | 88 | MCG | 36.667 |
| ZINC | 0.4 | 5.5 | MG | 57.292 |
| VITAMIN E | 0.5 | 50 | IU | 416.667 |
| VITAMIN B6 | 0.2739 | 2.08 | MG | 31.642 |
| BIOTIN | 0.01 | 97.5 | MCG | 40.625 |
| VITAMIN A | 250 | 2,800.00 | IU | 46.667 |
| VITAMIN D3 | 100 | 1,400.00 | IU | 58.333 |
| VITAMIN B12 | 0.01 | 15 | MCG | 6.25 |
| VITAMIN C | 1 | 42 | MG | 175.967 |
| FOLIC ACID | 0.1 | 480 | MCG | 20 |
| PANTOTHENIC | 0.91 | 24 | MG | 109.89 |
| ACID | | | | |

TABLE 2
Formulation of aerated core with premix of table 1

| | Amount | Amount |
|---|---|---|
| Ingredients | [wt-%] | [g] |
| MVM premix of table 1 | 11.42 | 180.00 |
| Malic Acid | 0.35 | 5.50 |
| Egg Albumin | 0.48 | 7.50 |
| Sugar | 31.72 | 500.05 |
| Corn Syrup | 13.10 | 206.50 |
| Gelatin | 1.44 | 22.70 |
| Tapioca Starch | 0.44 | 7.00 |
| Powdered Sugar | 40.21 | 633.91 |
| Nat. Strawberry Flavor | 0.86 | 13.50 |

(The composition comprises about 5 wt-% of water)

TABLE 3
Alternative formulation of aerated core with premix of table 1

| | Amount | Amount |
|---|---|---|
| Ingredients | [wt-%] | [g] |
| MVM premix of table 1 | 17.68 | 240.00 |
| Malic Acid | 0.21 | 4.40 |
| Egg Albumin | 0.29 | 6.00 |
| Sugar | 19.03 | 400.04 |
| Corn Syrup | 7.86 | 165.20 |
| Gelatin | 0.86 | 18.16 |
| Tapioca Starch | 0.27 | 5.60 |
| Powdered Sugar | 24.12 | 507.13 |
| Nat. Strawberry Flavor | 0.51 | 10.80 |

(The composition comprises about 5 wt-% of water)

TABLE 4
Aerated sugar coated confection fortified with
vitamins as dietary ingredients (Core of Table 2)

| | | Amount [g] |
|---|---|---|
| | Ingredients | (before drying) |
| | Marshmallow core of table 2 | 500.6 |
| Soft panning | Syrup | 24.7 |
| | powder sugar | 70.7 |
| Hard panning | Syrup | 195.1 |
| | Syrup with TiO₂ | 48.8 |
| | Syrup with Color and Flavor | 101.2 |
| Polishing | wax | 0.6 |
| | Total amount | 941.1 |

TABLE 5
Aerated sugar coated confection fortified with
vitamins as dietary ingredients (Core of Table 3)

| | | Amount [g] |
|---|---|---|
| | Ingredients | (before drying) |
| | Marshmallow core of table 3 | 342.3 |
| Soft panning | Syrup | 42.7 |
| | 10 × powder sugar | 116.0 |
| Hard panning | Syrup | 176.5 |
| | Syrup with TiO₂ | 38.5 |
| | Syrup with Color and Flavor | 66.0 |
| Polishing | wax | 0.5 |
| | Total amount | 782.0 |

### Example 2: Aerated Confection Fortified with Carotenoids as Dietary Ingredients

TABLE 6
Formulation of aerated confection
comprising lutein and zeaxanthin

| | Amount | Amount |
|---|---|---|
| Ingredients | [g] | [wt-%] |
| Nat. Zeaxanthin 5% CWS/S-TG (DSM) | 4.80 | 0.24 |
| FloraGLO Lutein 10% CWS/S-TG (DSM) | 125.00 | 6.25 |
| Citric Acid | 8.00 | 0.40 |
| Malic Acid | 7.33 | 0.37 |
| Egg Albumin | 10.00 | 0.50 |
| Sugar | 666.73 | 33.34 |
| Corn Syrup | 275.33 | 13.77 |
| Gelatin | 30.26 | 1.51 |
| Tapioca Starch | 9.33 | 0.47 |
| Powdered Sugar | 845.21 | 42.26 |
| Nat. Strawberry Flavor | 18.00 | 0.90 |

(The composition comprises about 5 wt-% of water)

TABLE 7
Aerated sugar coated confection fortified with
carotenoid as dietary ingredients (Core of Table 6)

| | | Amount [g] |
|---|---|---|
| | Ingredients | (before drying) |
| | core | 630.0 |
| Gumming | Gumming solution | 10.0 |
| Soft panning | Syrup | 64.0 |
| | powder sugar | 183.0 |
| Hard panning | Syrup | 451.7 |
| | Syrup with TiO₂ | 88.0 |
| | Syrup with Color and Flavor | 156.9 |
| Polishing | wax | 1.0 |

1. Non-frozen coated confection consisting of
(a) an aerated core and
(b) a shell coating the core,
wherein the core is fortified by at least one specific nutrient.

2. The non-frozen coated confection according to claim 1, which does not comprise any chocolate.

3. The non-frozen coated confection according to claim 1, wherein the core is a marshmallow.

4. The non-frozen coated confection according to claim 1, wherein the core comprises the following ingredients:
(i) sugar and/or sugar substitute,
(ii) water,
(iii) air, and
(iv) at least one whipping agent/aerator (usually a protein).

5. The non-frozen coated confection according to claim 4, wherein the aerated core comprises between 50-95 wt-%, based on the total weight of the core, of at least one sugar (Preferably the at least one sugar is chosen from the group consisting of sucrose, corn syrup (glucose syrup) and invert sugar) or sugar substitute.

6. The non-frozen coated confection according to claim 4, wherein the aerated core comprises up to 20 wt-%, based on the total weight of the core, of water.

7. The non-frozen coated confection according to claim 4, wherein the aerated core comprises up to of 50% (by volume) air.

8. The non-frozen coated confection according to claim 4, wherein the aerated core comprises between 1-5 wt-%, based on the total weight of the core, of at least one whipping agent/aerator (Preferably the whipping agent/aerator is a protein. More preferably are albumen (egg whites) and/or gelatin).

9. The non-frozen coated confection according to claim 1, wherein the aerated core comprises 2-30 wt-%, based on the total weight of the core, of at least one specific nutrient (Preferably of dietary ingredients (such as vitamins, carotenoids, minerals) as well as prebiotics and probiotics).

10. The non-frozen coated confection according to claim 1, wherein the aerated core comprises additional ingredients.

11. The non-frozen coated confection according to claim 1, wherein the shell coating is a sugar and/or sugar substitute coating.

12. The non-frozen coated confection according to claim 1, wherein the ration (related to the weight) of the core and the shell is from 1:0.05 to 1:2.

13. The non-frozen coated confection according to claim 1, wherein the non-frozen coated confection is sphere-like and has a size from 0.5 cm-3.0 cm.

14. Process of production of the non-frozen coated confection according to claim 1, wherein
(1) the aerated core is produced and then
(2) the aerated core is coated (by a sugar coating or sugar substitute coating.
